(19) United States
(12) Patent Application Publication
(10) Pub. No.: US 2016/0088803 A1
(43) Pub. Date: Mar. 31, 2016

(54) Body for Cultivation of a Plant

(71) Applicant: EDC horti-services B.V., Hoek Van Holland (NL)

(72) Inventor: Edwin DIJKSHOORN, Hoek Van Holland (NL)

(73) Assignee: EDC horti-services B.V., Hoek Van Holland (NL)

(21) Appl. No.: 14/592,625

(22) Filed: Jan. 8, 2015

(30) Foreign Application Priority Data
Sep. 29, 2014 (NL) 2013545

(51) Int. Cl. A01G 9/02; A01G 1/00

(52) U.S. Cl. CPC A01G 9/026; A01G 1/001

(57) ABSTRACT

Body for cultivation of a plant, comprising a growing medium. The body has a longitudinal axis and an external surface defined by: an upper surface part; a lower surface part opposite to the upper surface part; an outer surface part; and an inner surface part opposite to the outer surface part. In a first transition zone, one longitudinal side of the inner surface part fades into one longitudinal side of the outer surface part and, in a second transition zone, the other longitudinal side of the inner surface part fades into the other longitudinal side of the outer surface part. The body is transformable from a first shape into a second shape. Viewed in a plane transverse to the longitudinal axis, the outline of the second shape is determined by the outer surface part. In the first shape, the body is unfolded such that the inner surface part is exposed to the surrounding. In the second shape, the body is folded up such that the inner surface part is folded up onto itself.

### FIELD

The present invention relates to a rooting plug for cultivation of a plant.

### BACKGROUND

A rooting plug is a body comprising growing medium, like organic and/or non-organic fibres, peat, coconut etcetera. Growing medium is, in this application, the medium in which the roots of a plant develop, grow or are arranged. In general the growing medium can absorb or adsorb water for feeding the plant via its roots. Optionally, the growing medium can comprise nutrients and/or fertilizer and/or soil conditioners and/or other additives to promote plant growth or root growth as well.

Rooting plugs known from the prior art are typically in the form of a dimensionally stable body, like a cylindrical or block-shaped body, of growing medium having one or more holes in the upper surface into which a seed or un-rooted cutting or, occasionally, a (pre-)rooted cutting can be inserted. The size of these holes is typically 3-8 mm. In case of seeds it is also known to use a shallow indentation in the upper surface instead of a hole. Such a dimensionally stable body of growing medium might be essentially comprised of grains of sand bonded together in some manner so that these grains define so to say a solid body.

The rooting plugs as described in the preceding paragraph are not very suitable for (pre-)rooted cuttings and tissue cultured plants. This because the growing medium is too tough to stick the rooted plants, like (pre-)rooted cuttings and tissue cultured plants, in. Insertion of rooted plants into this kind of rooting plugs will result in root damage. One known solution for this is enlarging the holes for accommodating the root structure. However, this results in a loosely captured plant, which in turn does not promote a steady and healthy growth of the plants. Another known solution is so called sliced plugs.

Sliced plugs have either a slice across the upper surface or down along a side surface of the plug. Although satisfactory growth of plants has been attained with sliced plugs, it is difficult to open the slice with one hand and insert a rooted or un-rooted cutting or other plant part with the other hand. For example, the roots are to be pressed together in order to allow insertion via the opened slice into the growing medium. It is also know, see for example EP 2,572,571, to provide the plug with a side opening or slit. Also in this case roots or material containing roots, such as the tissue (of tissue cultured plants), still has to be pressed together and/or the plug has to be folded open at the side opening/slit in order to allow insertion of the cutting, (pre-)rooted cutting, seed, or other (part of a) plant—like a somatic embryo genesis plant, tissue cultured plant, etcetera—through the side opening/slit. Like in EP 2,572,571, the side opening/slit is closed after insertion of the (part of a) plant by squeezing together the parts of the plug adjacent the side opening/slit. In EP 2,572,571, viewed in a plane transverse to the height direction of the plug, the outline of the plug is both before closing the side opening(/squeezing together) and after closing the side opening(/squeezing together) determined by the same outer surface of the plug. Using a sliced plug or a plug with side opening, like EP 2,572,571, is laborious and time consuming due to the operations required on the plug, resulting in increased labour costs, and further roots might still be damaged due to contact with the walls of the side opening/slit upon insertion through the side opening/slit.

### SUMMARY OF THE INVENTION

The main object of the present invention is to provide an improved body of growing medium for cultivation of plants. A further object is to provide such a body which overcomes one or more of the problems addressed above.

The main object is according to a first aspect of the invention achieved by providing a body for cultivation of a plant, comprising a growing medium;

wherein the body has a longitudinal axis and an external surface;
wherein the external surface is defined by:
an upper surface part;
a lower surface part opposite to the upper surface part;
an outer surface part; and
an inner surface part opposite to the outer surface part;
   wherein the longitudinal axis extends from the upper surface part to the lower surface part;
   wherein, viewed in the direction of the longitudinal axis, the inner and outer surface parts each extend, from the upper surface part to the lower surface part and each have two opposing longitudinal sides extending in the direction of the longitudinal axis;
   wherein, in a first transition zone, one said longitudinal side of the inner surface part connects to one said longitudinal side of the outer surface part and, in a second transition zone, the other said longitudinal side of the inner surface part connects to the other said longitudinal side of the outer surface part;
   wherein the body is transformable from a first shape into a second shape;
   wherein, viewed in a plane transverse to the longitudinal axis, the outline of the second shape is determined by the outer surface part;
   wherein, in the first shape, the body is unfolded such that the inner surface part is exposed to the surrounding; and wherein, in the second shape, the body is folded up such that the inner surface part is folded up onto itself.

Although the body according to the invention is transformable from a first shape to a second shape, the body according to the invention still is dimensionally stable like (non-transformable) rooting plugs according to the prior art are.

When in the first shape, the body is in an unfolded state so that the inner surface part is exposed to the surrounding. This means that the inner surface part, with the body in the first shape, is freely accessible, not hindered by a narrow passage, like the slice, side opening or slit of prior art plugs (such as for example the so called “offset between the end sections 14, 15 of the side wall 13” in EP 2572571). The inner surface part being exposed in the first shape, allows easy and unhindered access of the plant part to be embedded in the body. The embedding itself takes place, after arranging the plant part to be embedded in contact with the inner surface part, by transforming the body from the first shape into the second shape. Damage to roots is prevented in this manner. When in the second shape, the inner surface part is folded up onto itself. With the body in the second shape, essentially the inner surface part is so to say collapsed against itself. Worded differently, in the second shape, the inner surface part is folded against itself at two or more sides of the centre of the plug shaped body, i.e. it is folded into—so to say—contact with itself at two or more sides of the centre of the plug shaped body. The inner surface part being folded against itself at two or more sides of the centre of the plug, results in that the plug—in the second shape—has a large internal surface over which the roots of the plant a) can easily spread themselves during growth of the roots and b) can be spread at the moment of placing a rooted part of a plant in/on the body. This in turn improves the capability of the roots for taking in water and nutrients.

When in the first shape, the body might be, and preferably is, in a relieved state, i.e. in a condition free of stress so that there is no tendency to transform by itself—for example due to material stresses or reaction stresses resulting from bending the body—into the second shape or any other shape. The body might already be in the first shape as from manufacturing the body. The body being—when in the first shape—in a relieved state provides that no effort or means are required to keep the body unfolded in its first shape. This simplifies placing of plant parts, like rooted plant parts, in/on the body considerably.

Viewed in a plane transverse to the longitudinal axis, the outline of the first shape is preferably determined by both the inner and outer surface part, whilst, viewed in a plane transverse to the longitudinal axis, the outline of the second shape is determined by only the outer surface part.

According to a further embodiment of the first aspect of the invention, the body has at least one bending zone extending from the upper surface part to the lower surface part, the at least one bending zone being more flexible than the adjacent zones of the body to facilitate folding up of the body from the first shape to the second shape. This bending zone facilitates easy transformation of the body from the first into the second shape.

According to a further embodiment of the first aspect of the invention, easy and reliable positioning of the plant part with respect to the body can be achieved when the inner surface part is provided with a positioning member, such as a recess and/or an abutment edge. Preferably this positioning member is, viewed in a plane transverse to the longitudinal axis and when the body is in the second shape, arranged adjacent the centre of the body.

According to a further embodiment of the first aspect of the invention, a transverse axis of the body is defined as a) extending, through the body, from the first transition zone to the second transition zone, b) having, when the body is in the first shape, an elongated line shaped configuration, like a curved or straight line, and c) having, when the body is in the second shape, a ring shaped configuration; and wherein, viewed in the direction of the transverse axis, the inner surface part has a profiled configuration allowing said folding up onto itself. The line shaped configuration of the transverse axis in the first shape of the body, implies that the body is like a strip with fully exposed first surface part. The ring shaped configuration of the transverse axis in the second shape of the body, surrounds so to say the plant part so that it is embedded inside the body. It is noted that the ring shaped configuration of the transverse axis of the body can be of any shape which is in circumferential direction so to say essentially closed, like round, oval, square, rectangular, hexagonal or otherwise.

According to a further embodiment of the first aspect of the invention, the profiled configuration is arranged to provide, when the body is in the second shape, a nesting of the inner surface part with itself. In the second shape, the profiled configuration results in a larger surface of overlap of the inner surface part onto itself. This larger overlap surface provides more contact surface for roots, which supports root growth and/or placing the roots onto the inner surface part. This nesting can, according to a further embodiment of the invention be such that, in the second shape of the body, the inner surface part interlocks—so to say—with itself preventing shifting of segments of the inner surface part with respect to each other. By preventing this shifting, damage to the roots or root structure of the plant part embedded inside the body is prevented.

According to a further embodiment of the first aspect of the invention, the profiled configuration of the inner surface part is such that, in the second shape of the body, a cavity is formed between the inner surface part—which inner surface part is folded up onto itself—, the cavity, viewed in circumferential direction around the longitudinal axis, being closed all around by the inner surface part. Providing such a cavity relieves the roots or root structure from pressure exerted by the inner surface part folded onto itself in the second shape. According to a further embodiment of the body, which according to the first aspect of the invention comprises a said cavity:
the cavity is, viewed in a plane transverse to the longitudinal axis and when the body is in its second shape, located in the centre of the body;
   and/or
the cavity, when the body is in the second shape, comprises a channel extending from the upper surface part in the direction of the longitudinal axis into the body, said channel optionally extending up to the lower surface part;
   and/or
the profiled configuration, when the body is in the first shape, comprises a recess in the first surface part, which recess provides said cavity when the body is in the second shape—This recess in the first surface part enables an easy and reliable positioning of the plant part with respect to the body so that the plant part to be embedded within the body is placed on the correct location.

According to a further embodiment of the first aspect of the invention, easy and reliable positioning of the plant part with respect to the body can also be achieved when, with the body in its first shape, the profiled configuration provides, viewed in the direction of the transverse axis, an abutment edge on the first surface part. Preferably this abutment edge is, viewed in a plane transverse to the longitudinal axis and when the body is in the second shape, arranged adjacent the centre of the body.

According to a further embodiment of the first aspect of the invention:
the outer surface part is essentially smooth;
   and/or
the body has, when the body is in the second shape and viewed in a plane transverse to the longitudinal axis, a round, oval, rectangular or triangular cross section;
   and/or
the body has, when the body is in the first shape and viewed in a direction perpendicular to the longitudinal axis, the body has an extended or outstretched configuration;
   and/or
the medium comprises organic fibres—like peat and/or coconut fibres—and/or non-organic fibres, rock wool, re-bonded foam, phenolic foam, polyurethane foam, PLA melt blown fibres, media wrapped with paper or netting.

In case the medium comprises organic or non-organic fibres or other particulate material, these fibres or particulate material might be bonded with a binder, like a polymer binder. The fibres or particulate material might however also be bonded in a different manner, for example needle punching or melt blowing fibres from a suitable material. According to the invention the body can be made from a bioplastic, for example a PLA (Polylactic acid also known as or polylactide). Wherein PLA includes PDLA (poly-D-lactide), PDLLA (poly-DL-lactide), PLLA (poly-L-lactide) as well as compositions comprising one or more of PLA, PDLA, PDLLA, and PLLA. The body according to the invention can be made easily from melt blown PLA fibres. Alternatively, the body according to the invention can be made from other known growing media like peat bonded by a binder.

According to a further embodiment of the first aspect of the invention, the body is provided with a closure mechanism for securing the body in its second shape. Such a closure mechanism might, for example be, a snap connection, having a first snap part at the first transition zone and a second snap part at the second transition zone, the snap parts mating with each other to keep the body in its second form when the first and second snap part interlock. According to another example, such a closure mechanism can be achieved by means of an adhesive or adhesive strip, arranged on the body near one transition zone and capable of adhering to the body near the other transition zone when the body is in its second shape.

According to a further embodiment of the first aspect of the invention, wherein a said cavity is formed in the profiled configuration, the cavity serves as said positioning member or as a part of a said positioning member.

According to a second aspect, the invention relates to an assembly comprising a body according to the first aspect of the invention in its second shape; and a plant stem between the inner surface part folded up onto itself.

According to a third aspect of the invention, the invention relates to a method of arranging a part of a plant, like a seed, cutting, or pre-rooted cutting, into a rooting plug, wherein the method comprises the steps of:
providing a body according to the first aspect of the invention in its first shape, in which first shape the body might, according to a further embodiment of the third aspect, be in a relieved state;
placing a said part of a plant on the inner surface part of the body; and
subsequently folding the body from its first shape into its second shape.

This method might additionally comprise the step of placing the folded up body with said part of a plant in between the inner surface part, into a plug cavity of a plant tray.

### BRIEF DESCRIPTION OF DRAWINGS

The present invention will be further explained with reference to the enclosed drawing. In this drawing:

FIGS. 1A-1C are schematic representations of a first embodiment; FIG. 1A being a view on the upper side of a body according to the first embodiment of the invention in its first shape; FIG. 1B being a view similar as in FIG. 1A, but now showing the body in its second shape; and FIG. 1C being a perspective view of the body in its second shape;

FIGS. 2A-2B are schematic representations of a second embodiment; FIG. 2A being a view on the upper side of a body according to the second embodiment of the invention in its first shape; FIG. 2B being a view similar as in FIG. 2A, but now showing the body in its second shape;

FIGS. 3A-3B are schematic representations of a third embodiment; FIG. 3A being a view on the upper side of a body according to the third embodiment of the invention in its first shape; FIG. 3B being a view similar as in FIG. 3A, but now showing the body in its second shape.

### DESCRIPTION OF EMBODIMENTS

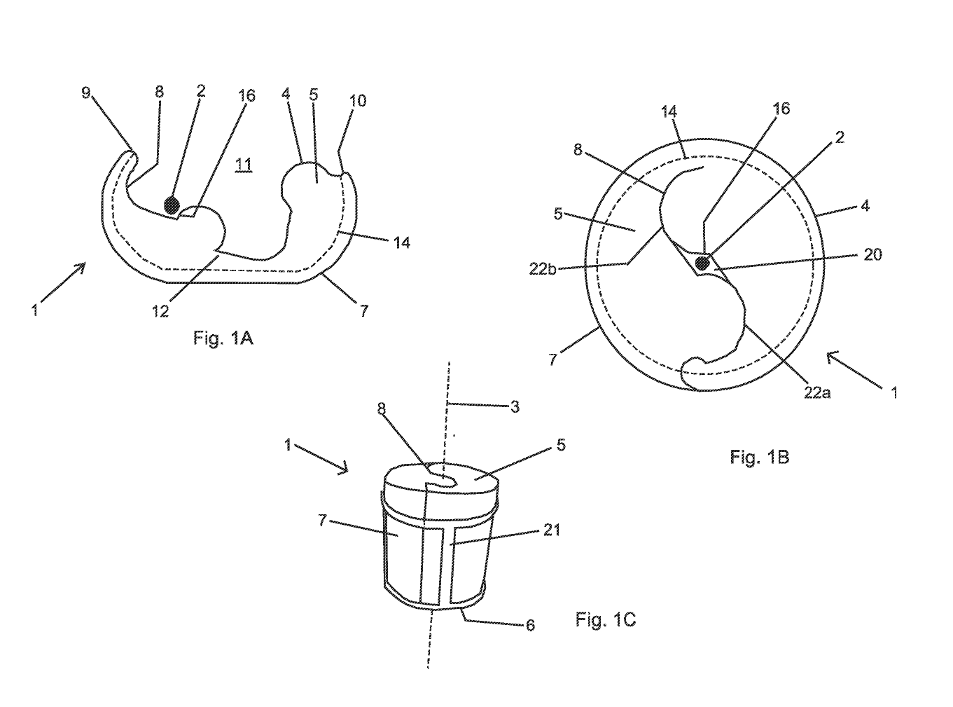

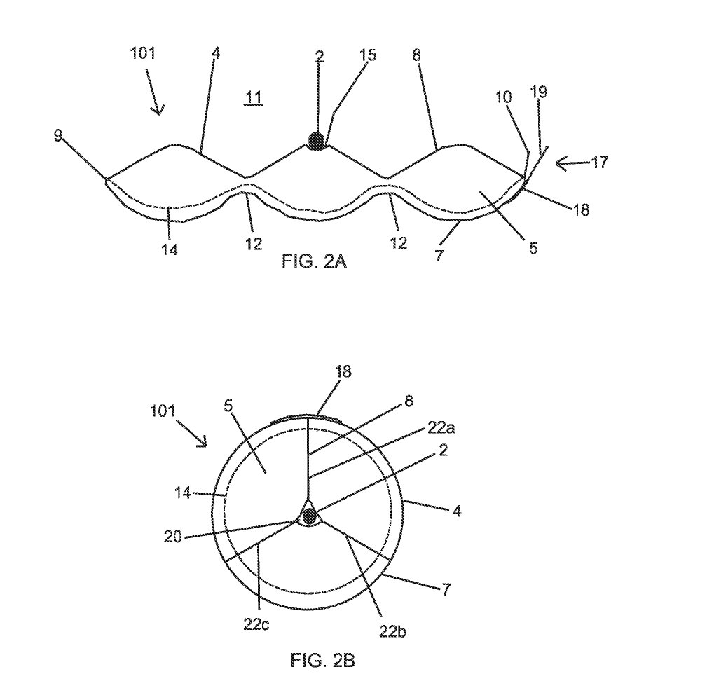

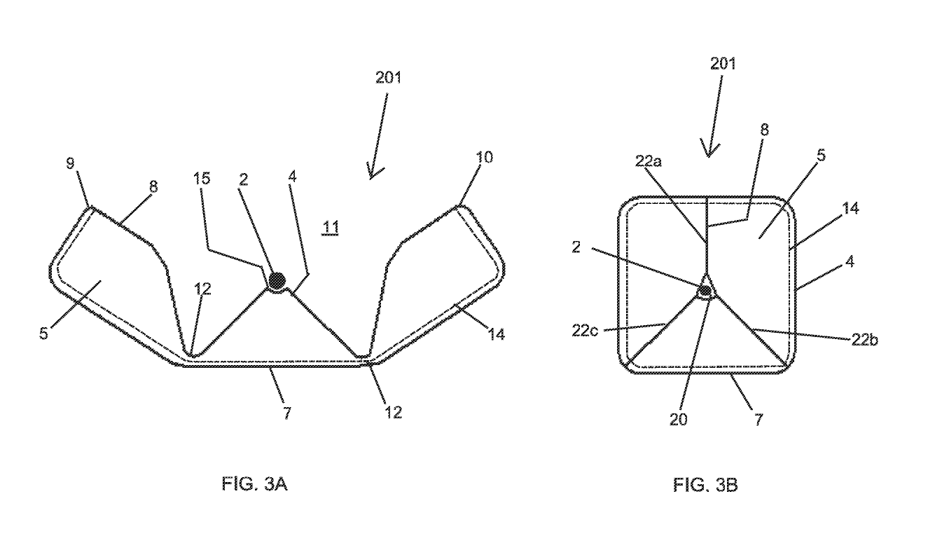

Referring to FIGS. 1A-1C, 2A-2B, and 3A-3B, it is noted that the first embodiment of the body according to the invention is indicated with reference number 1 (FIGS. 1A-1C), that the second embodiment of the body according to the invention is indicated with reference number 101 (FIGS. 2A-2B), that the third embodiment of the body according to the invention is indicated with reference number 201 (FIGS. 3A-3B), and that otherwise FIGS. 1A-1C, 2A-2B, and 3A-3B use the same reference numbers for corresponding parts of the first, second and third embodiment. The description of the drawing (the term drawing as used in this description indicates all figures) below relates to the embodiment of FIGS. 1A-1C as well as to the embodiment of FIGS. 2A-2B as well as to the embodiment of FIGS. 3A-3B, unless explicitly stated otherwise.

Referring to the drawing, the invention relates to what is known as a so called ‘rooting plug’ for cultivating plants. Contrary to known rooting plugs, the ‘plug’ according to the invention has a first shape from which it is transformable into a second shape. In the second shape, the ‘plug’ according to the invention has the form of a so called plug (see FIGS. 1B, 1C, 2B and 3B), but in the first shape the ‘plug’ according to the invention actually does not have the form of a plug, but the form is more like a strip shaped configuration (see FIGS. 1A, 2A and 3A). The invented device is therefore indicated as ‘a body for cultivation of plants’.

The body 1, 101, 201 comprises a growing medium. Growing media for a rooting plug are well known in the prior art. Basically all growing media known in the prior art or to be developed in future can be used in a body 1, 101, 201 according to the invention, provided it allows transformation from the first shape into the second shape as required according to the invention. As a general example of a growing medium suitable for use in the body according to the invention, a medium comprising organic and/or non-organic fibres—which might optionally be bonded with a binder, like a polymer binder—can be mentioned. For the body 1, 101, 201 according to the invention one might use a growing medium of melt blown PLA fibres or a growing medium of peat and/or coconut fibres bonded with a polymer binder. As an example only, a growing medium of polymer bonded peat is mentioned, which is used amongst others in the Flexi-plug 72R of Grow-Tech LLC, South Portland, Me., USA. As another example of a growing medium based on melt blown PLA fibres is mentioned, as is used in BioStrate also a product of Grow-Tech LLC, South Portland, Me., USA.

The body 1, 101, 201 can be an integral part made solely from a growing medium, but it can also contain other parts. For example it might be made from two or more parts, interconnected by a flexible strip material (like the strip 18 of the closure mechanism 17 as described in relation to the embodiment of FIGS. 2A-2B) allowing the transformation from the first shape into the second shape.

Returning to the drawing, the body 1, 101, 201 for cultivation of a plant 2 has an external surface 4 forming the outer surface of the body 1, 101, 201. The external surface 4 of the body 1, 101, 201 consists of 4 surface parts together defining the external surface 4. These surface parts are: an upper surface part 5, a lower surface part 6 opposite to the upper surface part 5, an outer surface part 7, and an inner surface part 8 opposite the outer surface part 7.

The body 1, 101, 201 further has a longitudinal axis 3 (only shown in FIG. 1C, but also present in the embodiments of FIGS. 2A-2B and 3A-3B). Referring to the manner of showing the longitudinal axis 3 in FIG. 1C, it is noted that FIG. 1C only shows the imaginary parts of the longitudinal axis extending outside the body, the part of the longitudinal axis 3 extending inside the body 3 is not shown for clarity reasons, but it will be clear that inner part of the longitudinal axis 3 extends from the upper surface part 5—starting at the lower end of the upper part of the longitudinal axis 3 as shown in FIG. 1C—through the body 1, 101, 201 to the lower surface part 6—ending at the upper end of the lower part of the longitudinal axis 3 as shown in FIG. 1C.

The longitudinal axis 3 extends from the upper surface part 5 to the lower surface part 6. Viewed in the direction of the longitudinal axis, the inner surface part 8 and outer surface part 7 each extend from the upper surface part 5 to the lower surface part 6. Further the inner surface part 8 and outer surface part 7 each have two opposing longitudinal sides extending in the direction of the longitudinal axis 3. One longitudinal side of the inner surface part 8 and one longitudinal side of the outer surface part 7 are connected in a first transition zone 9 to form a continuous transition from the inner surface part 8 to the outer surface part 7. Similar, the other longitudinal side of the inner surface part 8 and the other longitudinal side of the outer surface part 7 are connected in a second transition zone 10 to form a continuous transition from the inner surface part 8 to the outer surface part 7. The inner surface part 8 fades so to say into the outer surface part 7 at the locations of the transition zones 9 and 10.

The body 1, 101, 201 is transformable from a first shape shown in FIG. 1A, 2A and FIG. 3A to a second shape shown in FIGS. 1B, 1C, 2B and 3B. As can be seen in FIGS. 1B, 1C, 2B and 3B, the outline of the second shape is, viewed in a plane transverse to the longitudinal axis 3 fully determined by the outer surface part 7. In the second shape, the inner surface part 8 is completely embedded within the body 1, 101, 201 and inside the outer surface part 7.

In the first shape, the body 1, 101, 201 is in an unfolded state such that the inner surface part 8 is exposed to the surrounding 11. Exposed to the surrounding means that it is freely accessible for a plant part with/without root structure, so that the plant part is not hindered by a small passage through which it is to be passed. Referring to FIGS. 1A, 2A and 3A, exposed means, in the first and second embodiment, effectively that the body is in a kind of extended/outstretched configuration.

In the first shape/unfolded state, the body 1, 101, 201 as shown in the FIGS. 1A, 2A and 3A is in a relieved state in which it remains as from itself. The body 1, 101, 201 does not close automatically, neither is there any tendency to transform by itself in the direction of the second shape. This facilitates easy placing plants, seeds, rooted plant parts etcetera in/on the body. It is however noted that according to another embodiment some bias might be present in the body 1, 101, 201 in order to assist in closing the body from the first to the second shape.

As can be seen in FIGS. 1B, 2B and 3B, the body is in its second shape folded up such that the inner surface part 8 is folded up onto itself. In the centre a small cavity 20 might remain. In case a said small cavity 20 remains, the inner surface part 8 is folded against itself at two or more sides of the cavity, i.e. it is folded into contact with itself at two or more sides of the cavity 20. Worded more in general—covering for example the situation that there is no cavity in the centre—, the inner surface part 8 is folded against itself at two or more sides of the centre of the plug shaped body 1, 101, 201, i.e. it is folded into contact with itself at two or more sides of the centre of the plug shaped body 1, 101, 201.

In the first embodiment of FIG. 1A, the body 1 has one bending zone 12 which is more flexible, especially thinner, than the adjacent zones of the body 1 in order to facilitate folding up of the body from the first to the second shape. In the second embodiment of FIG. 2A and in the third embodiment of FIG. 3A, there are two such bending zones 12. It is noted that within the scope of the invention as determined by the claims, it is also conceivable to provide a body with more than two bending zones, like three, four, five or more bending zones.

A transverse axis 14 of the body 1, 101, 201 is defined as: extending through the body 1, 101, 201 from the first transition zone 9 to the second transition zone 10; having, when the body 1, 101, 201 is in the first shape, an elongated line shaped configuration (which might be straight or curved) see FIGS. 1A, 2A and 3A, and having, when the body 1, 101, 201 is in the second shape, a ring shaped configuration, see FIGS. 1B, 2B and 3B. As can be seen in FIGS. 1A-1C, the inner surface part 8 has a profiled configuration allowing nesting or interlocking of the inner surface part with itself. This prevents shifting of segments of the inner surface part with respect to each other.

As can be seen in the drawing, in the first as well as the second as well as the third embodiment of the invention the inner surface part 8 is profiled in such a manner that in the second shape a channel 20 is formed near the centre of the plug shaped body 1, 101, 201. In the first as well as the second and third embodiment of the body 1, 101, 201, the cavity is, in the second shape of the body, a channel 20 extending from the upper surface part 5 to the lower surface part 6. It is however to be noted that, within the scope of the invention as defined by the claims, it is very well conceivable that the cavity is just a cavity fully enclosed by the body, i.e. not being open towards the upper surface part or lower surface part. This can for example be the case in case a seed is to be placed inside the body. Referring to FIGS. 2A-2B and 3A-3B, the cavity can be the result of a recess 15 formed in the inner surface part. Referring to FIGS. 1A-1C, the cavity can also be the result of profiling the inner surface part 8 at two locations, which, when the body is in the second shape, lie opposite each other.

As can be seen further in the drawing, especially in FIGS. 1B, 1C, 2B and 3B, the inner surface part 8 of the body 1, 101, 201, when in its second shape, is at two or more sides of the centre/longitudinal axis 3 of the plug folded into contact with itself. In the first embodiment of FIGS. 1A-1C, this is at two opposing sides. In FIG. 1B, the areas where the ‘inner surface part 8 folded against itself’ actually contacts itself have been indicated with 22a and 22b. In the second embodiment of FIGS. 2A-2B and the third embodiment of FIGS. 3A-3B, this is at three sides spaced at angles of about 120° around the centre/longitudinal axis 3. In FIGS. 2B and 3B, the areas where the ‘inner surface part 8 folded against itself’ actually contacts itself have been indicated with 22a, 22b and 22c. These contact areas 22a, 22b, 22c allow easy spreading of the roots through the body during growth of the roots as well as at the moment of placing plant parts with roots in/on the body. This results in an enlarged surface of contact between the roots and the growing medium, and an improved growth of the plant as it can easier take in water and nutrients from the growing medium.

In order to provide a reference point for placing the plant part at the location desired, the inner surface part 8 can be provided with a recess (no. 15 in FIGS. 2A and 3A) and/or with an abutment (no. 16 in FIGS. 1A and 1B).

Referring to FIG. 1C, the body 1 can be maintained in its second shape by placing it in a cage 21 or in the plug hole of a so called plug tray. Referring to FIG. 2A, the body 101 can be maintained in its second shape by means of a closure mechanism 17, which in case of the embodiment of FIG. 2A has the form of a strip 18 of flexible material, which strip 18 is provided with an adhesive 19 allowing the free part of the strip of FIG. 1A to be adhered to the outer surface part 7, as shown in FIG. 2B. It is to be noted that the closure mechanism 17 of FIG. 2A or any other closure mechanism 17 can also be applied to the embodiment of FIGS. 1A-1C or FIGS. 3A-3B. Further a cage similar to the cage 21 in FIG. 1C can also be used with the embodiments of FIGS. 2A-2B and 3A-3B.

### LIST OF REFERENCE NUMBERS

1 body of first embodiment
2 plant
3 longitudinal axis
4 external surface
5 upper surface part
6 lower surface part
7 outer surface part
8 inner surface part
9 first transition zone
10 second transition zone
11 surrounding
12 bending zone
13 cavity
14 transverse axis
15 recess
16 abutment edge
17 closure mechanism
18 strip
19 adhesive surface
20 channel
21 cage
22a, 22b, 22c contact areas
101 body of second embodiment
201 body of third embodiment

1. A body of growing medium for cultivation of a plant, comprising;
a longitudinal axis and an external surface;
wherein the external surface is defined by:
an upper surface part;
a lower surface part opposite to the upper surface part;
an outer surface part; and
an inner surface part opposite to the outer surface part;
wherein the longitudinal axis extends from the upper surface part to the lower surface part;
wherein, viewed in the direction of the longitudinal axis, the inner and outer surface parts each extend, from the upper surface part to the lower surface part and each have two opposing longitudinal sides extending in the direction of the longitudinal axis;
wherein, in a first transition zone, one said longitudinal side of the inner surface part is connected to one said longitudinal side of the outer surface part and, in a second transition zone, the other said longitudinal side of the inner surface part is connected to the other said longitudinal side of the outer surface part;
wherein the body is transformable from a first shape into a second shape;
wherein, viewed in a plane transverse to the longitudinal axis, the outline of the second shape is determined by the outer surface part;
wherein, in the first shape, the body is unfolded such that the inner surface part is exposed to the surrounding;
wherein, in the second shape, the body is folded up such that the inner surface part is folded up onto itself; and
wherein the body is dimensionally stable.

2. Body according to claim 1,
wherein the body has at least one bending zone extending from the upper surface part to the lower surface part, the at least one bending zone being more flexible than the adjacent zones of the body to facilitate folding up of the body from the first shape to the second shape.

3. Body according to claim 1, wherein the inner surface part is provided with a positioning member, such as a recess and/or an abutment edge.

4. Body according to claim 3, wherein, viewed in a plane transverse to the longitudinal axis and when the body is in its second shape, the positioning member is located in the centre of the body.

5. Body according to claim 1,
wherein a transverse axis of the body is defined as:
extending, through the body, from the first transition zone to the second transition zone,
having, when the body is in the first shape, an elongated line shaped configuration, and
having, when the body is in the second shape, a ring shaped configuration; and
wherein, viewed in the direction of the transverse axis, the inner surface part has a profiled configuration allowing said folding up onto itself.

6. Body according to claim 5, wherein the profiled configuration is arranged to provide, when the body is in the second shape, a nesting of the inner surface part with itself.

7. Body according to claim 6, wherein said nesting is such that, in the second shape of the body, the inner surface part interlocks with itself so that shifting of segments of the inner surface part with respect to each other is prevented.

8. Body according to claim 5, wherein the profiled configuration of the inner surface part is such that, in the second shape of the body, a cavity is formed between the inner surface part, which cavity is, viewed in circumferential direction around the longitudinal axis, closed all around by the inner surface part.

9. Body according to claim 8, wherein, viewed in a plane transverse to the longitudinal axis and when the body is in its second shape, the cavity is located in the centre of the body.

10. Body according to claim 8, wherein, when the body is in the second shape, the cavity comprises a channel extending from the upper surface part in the direction of the longitudinal axis into the body, said channel optionally extending up to the lower surface part.

11. Body according to claim 8, wherein the cavity provides the positioning member of any of claims.

12. Body according to claim 1, wherein the outer surface part is essentially smooth.

13. Body according to claim 1, wherein, when the body is in the second shape and viewed in a plane transverse to the longitudinal axis, the body has a round, oval, rectangular or triangular cross section.

14. Body according to claim 1, wherein, when the body is in the first shape and viewed in a direction perpendicular to the longitudinal axis, the body has an extended configuration.

15. Body according to claim 1, wherein the growing medium comprises organic and/or non-organic fibres optionally bonded with a binder, like a polymer binder.

16. Body according to claim 1, wherein the growing medium comprises melt blown PLA fibres.

17. Body according to claim 1, wherein the body is provided with a closure mechanism for securing the body in its second shape.

18. Body according to claim 1, wherein the body is in a relieved state when it is in the first shape thereof.

19. Assembly comprising:
a body according to claim 1 in its second shape; and
a plant stem between the inner surface part folded up onto itself.

20. Method of arranging a part of a plant, like a seed, cutting, or pre-rooted cutting, into a rooting plug, wherein the method comprises the steps of:
providing a body according to claim 1 in its first shape;
placing a said part of a plant on the inner surface part of the body; and
subsequently folding the body from its first shape into its second shape.

21. Method according to claim 20, additionally comprising the step of placing the folded up body with said part of a plant in between the inner surface part, into a plug cavity of a plant tray.

22. The body according to claim 1, wherein the growing medium comprises fibres or particulate material bonded with a binder.
